(19) United States
(12) Patent Application Publication
(10) Pub. No.: US 2013/0171315 A1
(43) Pub. Date: Jul. 4, 2013

(54) SWEETENER COMPOSITION

(71) Applicants: Christopher Edward Delfosse, Minneapolis, MN (US); Andres Del-Rosal, Plymouth, MN (US); Bruce Michael Furlano, Vernon Hills, IL (US)

(72) Inventors: Christopher Edward Delfosse, Minneapolis, MN (US); Andres Del-Rosal, Plymouth, MN (US); Bruce Michael Furlano, Vernon Hills, IL (US)

(73) Assignee: CARGILL, INCORPORTED, Wayzata, MN (US)

(21) Appl. No.: 13/816,977

(22) PCT Filed: Aug. 18, 2011
(86) PCT No.: PCT/US11/48210

§ 371 Date: Feb. 14, 2013

Related U.S. Application Data
(60) Provisional application No. 61/374,982, filed on Aug. 18, 2010.

(51) Int. Cl. A23L 1/236

(52) U.S. Cl. CPC A23L 1/2364
USPC 426/548

(57) ABSTRACT

A sweetener composition comprising at least one high intensity sweetener, erythritol, and at least one or more hydrocolloid, and beverage or food compositions containing such a sweetener composition, are disclosed.

### CROSS REFERENCE TO RELATED APPLICATION

This application claims the benefit of the U.S. Provisional Patent Application Ser. No. 61/374,982, filed Aug. 18, 2010, entitled SWEETENER COMPOSITION, which is hereby incorporated by reference in its entirety.

### FIELD

The present invention relates to a sweetener composition, and beverage or food compositions containing such a sweetener composition.

### BACKGROUND

The use of sweeteners in food and beverages is a norm in everyday life. Sweeteners are used, for example, in beverages, baked goods, desserts and snacks. Nutritive sweeteners such as sugars are a significant source of calories. High caloric intake has been associated with various concerns, such as weight gain, leading to health problems. As consumers are more health and wellness conscious, the calorie contents of foods and beverages are an important feature that consumers consider before purchasing products. Particularly, high calorie foods and beverages have been shunned by consumers who are concerned with their wellness.

Food and beverage manufacturers, to cater to health and wellness conscious consumers, have marketed foods and beverages with reduced calorie contents by using sugar substitutes. A significant market exists for reduced calorie foods and beverages. However, reduced calorie foods tend to be distasteful, due to off-taste or lingering bitter or tart aftertaste from the sugar substitute. Furthermore, good mouthfeel or body is missing due to the lack of sugar solid content compared to non-low calorie food. This is particularly true with reduced calorie beverages.

Small molecular weight carbohydrates have been added to reduced calorie food products, particularly with respect to beverages, in an attempt to deliver sucrose-identical sensory characteristics to such products. For example, low-calorie high intensity sweeteners generally permit the development of reduced calorie products through an ability to elicit sufficient sweetness at a very low concentration of the sweetener, but they are generally unable to mimic other sensory characteristics of sucrose, particularly mouthfeel and body. Hence, products may contain erythritol as an additive to improve other qualities of the food or beverage product beyond its sweetness. Erythritol, in combination with high intensity sweeteners, allows for a reduced calorie product that exhibits both the sweetness characteristics of sucrose and other important sensory characteristics such as mouthfeel, flavor and aftertaste.

### SUMMARY

In one aspect, the present invention provides a sweetener composition, which comprises from about 0.2 wt. % to about 5.0 wt. %, preferably 1.1 wt. % to about 2.7 wt. % of one or more high intensity sweeteners; from about 92.0 wt. % to about 99.0 wt. %, preferably 95.0 wt. % to about 98.0 wt. % of erythritol; and from about 0.3 wt. % to about 3.0 wt. %, preferably 0.6 wt. % to about 1.9 wt. % of one or more hydrocolloids. In a particular aspect, the high intensity sweetener of the sweetener composition is a rebaudioside A, such as the rebiana sweetener available from Cargill, Incorporated. In another particular aspect, the erythritol of the sweetener composition is ZEROSE erythritol available from Cargill, Incorporated. In another particular aspect, the hydrocolloid of the sweetener composition is a pectin, such as a citrus pectin, and/or gum arabic, available from Cargill, Incorporated. In one embodiment, the sweetener composition is agglomerated. In a particular embodiment, the agglomerate is a rebaudioside A-pectin agglomerate.

In another aspect, the present invention relates to a calorie-reduced beverage or food composition comprising a one or more one high intensity sweetener having a SEV of from about 2.0% to about 10.0%; an erythritol having a SEV of from about 0.9% to about 1.85%; a one or more hydrocolloid having an equivalent mouthfeel of from about 0.5 wt. % to about 3.4 wt. % erythritol, where the weight ratio of hydrocolloid:erythritol is from about 1:50 to about 1:100; and optionally, a one or more hydrocolloid having an apparent SEV of less than about 0.3, where the ratio of hydrocolloid (wt/wt %) to apparent SEV is from about 1:15 to about 1:50. In another aspect, the present invention relates to a calorie-reduced beverage or food composition where the erythritol is reduced from about 25% to about 60%, compared to a beverage or food composition containing erythritol and rebaudioside A in the absence of a hydrocolloid where the SEV of the erythritol is from about 1.5% to about 3.3%. In a further aspect, the present invention relates to a method to reduce the amount of erythritol in a beverage or food composition by adding the sweetener composition of the present invention in the beverage or food composition. In yet a further aspect, the present invention relates to a method of making a calorie reduced beverage or food composition by adding the sweetener composition of the present invention in the beverage or food composition.

### BRIEF DESCRIPTION OF THE DRAWINGS

FIG. 1 shows the curves of the dissolution of a rebaudioside A-pectin agglomerate compared to dry blended forms.

### DETAILED DESCRIPTION

### Introduction

Erythritol is a natural sweetener that has zero sugar, zero calories and zero aftertaste. Other benefits of erythritol include that it does not promote tooth decay, it does not affect blood sugar and therefore is an alternative sweetener choice for people with diabetes, and it is absorbed by the body and therefore unlikely to cause gastric side effects compared to other polyols. An additional benefit is that erythritol tastes great by itself, but it is about 30% to 40% less sweet than sucrose as a sweetening ingredient. While less sweet than sucrose, it is known that using erythritol with high intensity sweeteners will change the sweetness to be more like that of sugar. In addition, it prevents the after-taste and off-flavors sometimes associated when high intensity sweeteners are used alone. Erythritol also provides mouthfeel similarly to other nutritive sweeteners commonly used in foods and beverages. Because of the many benefits of erythritol, in recent months the demand for erythritol has exceeded the supply. Accordingly, there is a need to find alternatives in order to use less erythritol in foods and beverages.

### TERMS AND DEFINITIONS

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more of these stated alternative elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and claims.

Definitions of common terms in chemistry may be found in Richard J. Lewis, Sr. (ed.), Hawley's Condensed Chemical Dictionary, published by John Wiley & Sons, Inc., 1997 (ISBN 0-471-29205-2).

Explanations of certain, specific terms are provided below or generally within the text of the application.

The term “beverage”, as used herein, means a drinkable composition. Beverages include, but are not limited to the following: carbonated and non-carbonated, alcoholic and non-alcoholic drinks including but not limited to carbonated water, flavored water, carbonated flavored water, drinks containing juice (juice derived from any fruit or any combination of fruits, juice derived from any vegetable or any combination of vegetables) or nectar, milk obtained from animals, milk product derived from soy, rice, coconut or other plant material, sports drinks, vitamin enhanced sports drinks, high electrolyte sports drinks, highly caffeinated high energy drinks, coffee, decaffeinated coffee, tea, tea derived from fruit products, tea derived from herb products, decaffeinated tea, wine, champagne, malt liquor, rum, gin, vodka, other hard liquors, beer, reduced calorie beer-type beverages, non-alcoholic beer, and other beer-type beverages obtained from a cereal solution such as beer, ale, stout, lager, porter, low alcoholic beer, alcohol-free beer, kvass, rye-bread beer, shandy, malt drinks and the like. Cereal in this context refers to grains commonly used to make the beverages listed above and other similar beverages. However, the term “beverage” excludes 100% juice based-beverages.

The term “erythritol” (also referred to as “ErOH”), as used herein, means to a naturally-occurring sugar alcohol that is well known as a sugar substitute and has been approved for use as a sweetener throughout the world. Erythritol is a tetrahydric polyol (butane-1,2,3,4-tetraol) having the structural formula OHCH₂—CHOH—CHOH—CH₂OH (C₄H₁₀O₄).

The term “high intensity sweetener”, as used herein, means, generally, any sweetener found in nature or nature identical which may be in raw, extracted, purified, or any other form, singularly or in combination thereof and characteristically have a sweetness potency greater than sucrose (common table sugar) yet have comparatively less calories. Even if the high intensity sweetener has the same number of calories as sucrose, the usage amount of high intensity sweetener is considerably less than sucrose thereby reducing the total calorie amount. For instance, because high intensity sweeteners are compounds having a sweetness that is many times that of sucrose, much less high intensity sweetener is required to obtain a similar effect as sucrose and energy contribution is therefore negligible. Non-limiting examples of high intensity sweeteners suitable for embodiments of the present invention include rebaudioside A, rebaudioside B, rebaudioside C, rebaudioside D, rebaudioside E, rebaudioside F, dulcoside A, rubusoside, stevia, stevioside, mogroside IV, and mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, polypodoside A, pterocaryoside A, pterocaryoside B, mukurozioside, phlomisoside I, periandrin I, abrusoside A, and cyclocarioside I, sodium saccharin, cyclamate, aspartame, acesulfame potassium, sucralose, alitame, neotame, neohesperidin dyhydrochalone (NHDC) and combinations thereof. High intensity sweeteners also include modified high intensity sweeteners. Modified high intensity sweeteners include high intensity sweeteners which have been altered naturally. For example, a modified high intensity sweetener includes, but is not limited to, high intensity sweeteners which have been fermented, contacted with enzyme, or isomers of high intensity sweeteners, derivatized or substituted on the high intensity sweetener.

The term “mouthfeel”, as used herein, is the tactile sensations perceived at the lining of the mouth, including the tongue, gums and teeth. Mouthfeel includes, but is not limited to, “body” (as defined in the Examples section) and “mouthcoating” (also defined in the Examples section).

The term “steviol glycosides”, as used herein, refers to any of the glycosides of the aglycone steviol (ent-13-hydroxykaur-16-en-19-oic acid) including, but not limited to, stevioside, rebaudioside A (also referred to as “reb A”), rebaudioside B, rebaudioside C, rebaudioside D, rebaudioside E, rebaudioside F, dulcoside A, rubusoside, steviolmonoside, steviolbioside, 19-O-β glucopyranosol-steviol, and isomers and derivatives of the aforementioned glycosides.

### Sweetener Composition

In one aspect, the present invention provides a sweetener composition, which comprises from about 0.2 wt. % to about 5.0 wt. % of one or more high intensity sweeteners, from about 92.0 wt. % to about 99.0 wt. % of erythritol, and from about 0.3 wt. % to about 3.0 wt. % of one or more hydrocolloids. Preferably, the one or more high intensity sweeteners is from about 1.1 wt. % to about 2.7 wt. %, the erythritol is from about 95.0 wt. % to about 98.0 wt. %, and the one or more hydrocolloids is from about 0.6 wt. % to about 1.9 wt. %. Preferably, the high intensity sweetener is a steviol glycoside. Particular stevia compounds range in sweetness from 20 to 450 times that of sucrose, are heat and pH stable, do not ferment, and do not induce a glycemic response when ingested by mammals. Some of these latter features make them attractive for use as natural sweeteners for diabetics and other people on carbohydrate-controlled diets. Many of the steviol glycosides, whether isolated from stevia plants, isolated from other plants, or chemically synthesized, can be used as a high intensity sweetener.

In one embodiment, extracts of high intensity sweeteners may be used in any purity percentage. In another embodiment, when a high intensity sweetener is used as a non-extract, the purity of the high intensity sweetener may range for example from about 25% to about 100%. In another example, the purity of the high intensity sweetener may range from about 70% to about 100%; from about 80% to about 90%; from about 90% to about 100%; from about 95% to about 100%; from about 96% to about 99%; from about 97% to about 98%; from about 98% to about 99%; and from about 99% to about 100%.

Purity, as used herein, represents the weight percentage of a respective high intensity sweetener compound present in a high intensity sweetener extract, in raw or purified form. In one embodiment, a steviolglycoside extract comprises a particular steviolglycoside in a particular purity, with the remainder of the stevioglycoside extract comprising a mixture of other steviolglycosides.

To obtain a particularly pure extract of a high intensity sweetener, such as rebaudioside A, it may be necessary to purify the crude extract to a substantially pure form. Such methods generally are known to those of ordinary skill in the art. An exemplary method for purifying a high intensity sweetener such as rebaudioside A, is described in published patent application WO2008/091547 entitled “Method of producing purified rebaudioside A compositions using solvent/antisolvent crystallization,” which is incorporated herein by reference in its entirety.

A steviol glycoside of particular interest is rebaudioside A. It has a sweetness that is several hundred times that of sucrose. Thus, in one embodiment of the present invention the high intensity sweetener is rebaudioside A in a purity greater than or equal to about 97% rebaudioside A by weight on a dry basis. In another embodiment of the present invention, the high intensity sweetener is rebaudioside A in a purity greater than or equal to about 95% rebaudioside A by weight on a dry basis. In another embodiment of the present invention, the high intensity sweetener is rebaudioside A in a purity greater than or equal to about 90% rebaudioside A by weight on a dry basis. In still another embodiment, the high intensity sweetener is rebaudioside A in a purity greater than or equal to about 80% rebaudioside A by weight on a dry basis. In yet another embodiment of the present invention, the high intensity sweetener is rebaudioside A in a purity greater than or equal to about 60% rebaudioside A by weight on a dry basis.

The particular high intensity sweetener (or combination of high intensity sweeteners) selected depends on the characteristics desired in the resulting sweetener. Where a “natural,” sweetener is desired, possible high intensity sweetener plant glycosides and other compounds that occur in nature and have a sweet quality with or without caloric value. Where a non-natural high intensity sweetener can be used, aspartame, saccharin, or other synthetic sweeteners may be used.

High intensity sweeteners for use in the present invention may have characteristics that make them undesirable for use on its (their) own. For example, the high intensity sweetener may have a bitter taste, astringent taste or aftertaste, a sweetness that is slower, or a sweetness that is different in duration than known palatable sweeteners, such as sucrose. The high intensity sweetener may also have a sweet quality that is slower in achieving full intensity and longer in duration compared to sucrose.

The hydrocolloids may be chosen from the group consisting of gum arabic, nOSA (n-octenyl succinic anhydride) maltodextrin, carboxymethylcellulose, guar gum, locust bean gum, cassia gum, pectin from botanical sources (e.g., apple, citrus, soy, potato, etc.), carrageenan, alginate, xanthane, and mixtures thereof. Preferably, the one or more hydrocolloid is a pectin and may be chosen from the group consisting of sugar beet pectin, apple pectin, citrus pectin, and mixtures thereof. Without wishing to be bound by theory, it is believed that the pectin acts as a lubricant. The lubricating effect of the pectin results in a fluid-like cushion that can sustain pressure created inside the mouth cavity during swallowing. Hence, friction forces between the tongue, the gums, teeth, and the palate are reduced.

In another aspect, the sweetener composition of a one or more high intensity sweetener, an erythritol, and a one or more hydrocolloid may be agglomerated. In a particular embodiment, the agglomerate is a rebaudioside A, erythritol, pectin agglomerate. In one embodiment, the one or more high intensity sweetener and the one or more hydrocolloid of the sweetener composition are agglomerated to form a high intensity sweetener-hydrocolloid agglomerate. In a particular embodiment, the agglomerate is a rebaudioside A-pectin agglomerate. Methods of agglomerating are well known. A sweetener composition agglomerate is desirable by many beverage manufacturers to reduce product loss through dusting, to have consistent product formulation without diluting the sweetness of the high intensity sweetener, and for increase ease of manufacturing by working with one ingredient versus two. Another added benefit is that the sweetener composition agglomerate has a high surface area thus rapidly dissolving in beverage formulations (i.e., increased dissolution). Agglomeration may include other methods that combine several ingredients in order to obtain the aforementioned benefits that beverage manufacturers desire, such as, by way of example, compaction, compression, spray drying, granulation, and the like. In other embodiments, therefore, the sweetener composition can be compacted, compressed, spray dried, and granulated.

### Calorie-Reduced Beverage or Food Composition

The sweetener composition according to the present invention can be used with a variety of edible products including a variety of beverages, fruit, dairy products, bakery products, confections, and the like. For example, it can be added to a beverage or food formulation to obtain a calorie reduced beverage or food composition having the desired balance of sweetness and other sensory characteristics of an equivalent full calorie beverage or food composition. The calorie reduction may be from 1 to 100% reduction of the caloric value of the beverage or food composition; preferably from 25 to 100%, more preferably from 50 to 100%, most preferably from 80 to 100%. Such a calorie-reduced beverage or food composition could be a “light beverage” or “zero calorie beverage” or “reduced calorie food” as they are commonly known in the market. The use of one or more hydrocolloids in combination with a one or more high intensity sweetener is particularly effective in improving the mouthfeel of a calorie reduced beverage or food composition, and providing a temporal profile that is closer to that which can be achieved by the addition of erythritol. In using the sweetening composition according to the present invention, it may be incorporated in the edible food or beverage composition to be sweetened in any appropriate manner. For example, it may be added directly to the beverage or food composition to be sweetened or it may be first combined with a diluent and then added to the beverage or food composition or any component of the ultimate composition at any stage in the manufacturing process.

In one aspect, the present invention provides a beverage or food composition, which comprises one or more high intensity sweeteners with a certain sucrose equivalent value, an erythritol with a certain sucrose equivalent value, and one or more hydrocolloids. The beverage or food composition according to the present invention exhibits sweetness from the high intensity sweetener(s) and erythritol, and mouthfeel and, unexpectedly enhanced sweetness, attributes contributed by the hydrocolloid(s), even while reducing the amount of erythritol in the beverage or food composition compared to a beverage or food composition having one or more high intensity sweeteners and erythritol. The beverage or food composition according to the present invention also provides a temporal profile that is more sugar-like and/or more balanced providing a flavor equivalent to a composition with increased erythritol.

In one embodiment, the calorie-reduced beverage or food composition has a one or more one high intensity sweetener having a SEV of from about 2.0% to about 10.0%, preferably from about 4.0% to about 7.0%; an erythritol having a SEV of from about 0.9% to about 1.85%; a one or more hydrocolloid having an equivalent mouthfeel of from about 0.5 wt. % to about 3.4 wt. % erythritol, preferably from about 0.9 wt. % erythritol to about 2.2 wt. % erythritol, where the weight ratio of hydrocolloid:erythritol is from 1:50 to 1:100; and optionally, a one or more hydrocolloid having an apparent SEV of less than about 0.3, preferably less than about 0.7, where the ratio of hydrocolloid (wt/wt %) to apparent SEV is from about 1:15 to about 1:50. In another embodiment, the calorie-reduced beverage or food composition contains an amount of erythritol that is reduced from about 25% to about 60%, compared to a beverage or food composition containing erythritol and rebaudioside A in the absence of a hydrocolloid where the SEV of the erythritol is from about 1.5% to about 3.3%.

The beverage or food composition has one or more high intensity sweetener with a sucrose equivalent value of from about 2.0% to about 10% to compensate for the reduction of the erythritol and to reach the final desired sweetness. In a preferred embodiment, the one or more high intensity sweetener has a sucrose equivalent value of from about 4.0% to about 7.0%. Determination of the type and amount of high intensity sweetener with a particular sucrose equivalent value will vary based on the type of beverage, and would be within the capacity of one of skill in the art. In a further aspect, the present invention relates to a method to reduce the amount of erythritol in a beverage or food composition by adding the sweetener composition of the present invention in the beverage or food composition. In yet a further aspect, the present invention relates to a method of making a calorie reduced beverage or food composition by adding the sweetener composition of the present invention in a beverage or food composition.

Early researchers in the food texture-taste interactions showed that high levels of solids or added food thickeners, such as a hydrocolloid, generally resulted in a decrease in the sweetness of the product. For example, (a) significant texture-taste interaction was reported in carboxymethylcellulose solution with sucrose and higher levels produced significant reductions in perceive sweetness; (b) hydrocolloid gels (carrageenan, cornstarch, low methoxyl pectin, agar and gelatin) with sodium sucaryl where carrageenan, low methoxyl pectin, agar and gelatin gels showed the lowest sweetness while cornstarch gels showed less sweetness reduction; (c) sodium carboxymethylcellulose solution with glucose where decreased in sweetness was seen with increased viscosity and concentration of sodium carboxymethylcellulose; (d) five hydrocolloids (carboxymethylcellulose-medium viscosity, carboxymethylcellulose-low viscosity, sodium alginate, xanthan gum, and hydroxypropylcellulose) solutions with sucrose and saccharin where sucrose intensity was suppressed. The suppression was related to the type of hydrocolloid and not the viscosity. However several hydrocolloids seemed to enhance the sweetness of saccharin; (e) four thickeners (cornstarch, gum tragacanth, carboxymethylcellulose, and methyl cellulose) solutions with sucrose showed the sweetness was lower compared to solution without thickeners, in solutions of carboxymethylcellulose and cornstarch; (f) cornstarch, guar gum, and carboxymethylcellulose solutions with sucrose showed shear thinning behavior was related to sweetness masking of sucrose; (g) carrageenan with sucrose in dairy dessert where some types of carrageenen masked sweetness; (h) hydroxypropylmethylcellulose (HPMC), guar gum, and carrageenan solutions with aspartame, sucrose, fructose and neohesperidin dihydrochalcone where the sweetness of sucrose was found to be significantly reduced in the more viscous guar gum solution. Aspartame sweetness was reduced in the carrageenan above coil-overlap concentration. The perceived sweetness of 6.5% sucrose in 1.0% HPMC did not differ significantly from that of 5% sucrose in 0.2% HPMC, and the magnitude of effect with aspartame was about the same; and (i) guar gum solutions with sucrose where a decrease in sweetness was seen at concentration higher than the coil-overlap concentration. The prior art demonstrates that one or more hydrocolloids generally decreases sweetness, and, in the present disclosure, it was unexpectedly found that the hydrocolloid(s) appears to increase overall sweetness in a calorie-reduced beverage or food composition.

### EXAMPLES

The following examples are presented to illustrate the present invention and to assist one of ordinary skill in making and using the same. The examples are not intended in any way to otherwise limit the scope of the invention.

### Sucrose Equivalent Value (“SEV”)

The perception of sweetness is often referred to in terms of sucrose equivalence. Sucrose equivalence is a standard used to measure sweetness as compared to the baseline of sucrose. All sweeteners, including sugarless and high intensity sweeteners, are measured against the standard sweetener, sucrose. Accordingly, the sweetener profile and perceived level of sweetness should, ideally, be comparable to that of sucrose. Measuring the perceived sweetness of a solution is typically done by calculating its SEV. Sucrose equivalence may be defined as the amount of sweetener required to impart the comparable or equivalent level of sweetness perceived from a given amount of sucrose. One method of measuring the perceived sweetness of a solution is to match it with a stock sucrose solution of known concentration. For example, the compound of interest is added at a predetermined concentration to a water solution. A number of expert panel members then taste the solution and compare it to a battery of stock sucrose solutions ranging from 0.5% to 10% at increments of 0.5%. Each panel member decides which sucrose solution is equisweet with the solution containing the compound of interest. The mean value is then reported as the SEV.

The SEV of rebaudioside A at 22° C. is calculated as follows:

SEV_{reb A}=11.26×reb A ppm/(253.7+reb A ppm)

and the SEV of erythritol is calculated as follows:

SEV_{ErOH}=0.6×erythritol wt. %

In addition, in the present disclosure, surprisingly, it was found that a one or more hydrocolloid appears to increase overall sweetness in a calorie-reduced beverage or food composition. Hence, a one or more hydrocolloid has an “apparent SEV”, which is calculated as follows: if a sample does not contain a hydrocolloid (“sample A”), the total SEV of sample A is calculated by (SEV_{reb A}+SEV_{ErOH}). If, however, a sample contains a hydrocolloid (“sample B”), and the total SEV of sample B is less than total SEV of sample A, and samples A and B taste the same or is similar (i.e., have the same sweetness), then the hydrocolloid has an “apparent SEV”:

apparent SEV_{hydrocolloid}=[sample A(SEV_{reb A}+SEV_{ErOH})−sample B(SEV_{reb A}+SEV_{ErOH})]

### Quantitative Descriptive Analysis (QDA)

The QDA method is based on the principle of a trained panelist's ability to verbalize perceptions of a product in a reliable manner. The method embodies a formal screening and training procedure, development and use of a sensory language, and the scoring of products on repeated trials to obtain a complete, quantitative description. QDA is well known in the art.

### Triangle Difference Test (“Triangle Test”)

The Triangle Test covers a procedure for determining whether a perceptible sensory difference exists between samples of two products. Three coded samples, of which two are the same, are presented to each panelist and each panelist is asked to pick out which sample they feel is different from the other two. The Triangle Test is well known in the art.

### Duo Trio Difference Test (“Duo Trio Test”)

The Duo Trio Test also covers a procedure for determining whether a perceptible sensory difference exists between samples of two products. Three coded samples are presented to each panelist. Of the three samples, two are the same where one of the two is coded as a reference sample. Each panelist is asked to pick out which sample is the same as the reference sample. The Duo Trio Test is well known in the art.

The individual ingredients used in the following examples are from Cargill, Incorporated (Wayzata, Minn. USA). In particular, reb A is rebiana with purity about greater than or equal to 97%; erythritol is ZEROSE erythritol.

### Example 1A

### Lemon Lime Carbonated Beverages

### 1.1 Formulations of Calorie-Reduced Lemon Lime Carbonated Beverages

Calorie-reduced lemon lime carbonated beverages were prepared according to the following formulations set forth in Table 1A:

Pair 1: Sample 1: Reb A+1.5% erythritol, and

Sample 2: Reb A+1.5% erythritol+pectin;

Pair 2: Sample 3: Reb A+2.5% erythritol, and

Sample 4: Reb A+2.5% erythritol+pectin;

Sample 5: Reb A+3.5% erythritol (control)

TABLE 1A
Formulations of calorie-reduced lemon lime carbonated beverages

| | Sample 1 | Sample 2 | Sample 3 | Sample 4 | Sample 5 |
|---|---|---|---|---|---|
| Ingredient | (wt/wt %) | (wt/wt %) | (wt/wt %) | (wt/wt %) | (wt/wt %) |
| Water | 98.058 | 98.008 | 97.061 | 97.04 | 96.064 |
| Citric acid | 0.125 | 0.125 | 0.125 | 0.125 | 0.125 |
| Sodium | 0.024 | 0.024 | 0.024 | 0.024 | 0.024 |
| citrate | | | | | |
| Erythritol | 1.5 | 1.5 | 2.5 | 2.5 | 3.5 |
| Reb A | 0.0426 | 0.0425 | 0.0400 | 0.0363 | 0.037 |
| Lemon lime | 0.25 | 0.25 | 0.25 | 0.25 | 0.25 |
| flavor | | | | | |
| Pectin | 0.0 | 0.03 | 0.0 | 0.015 | 0.0 |
| Total | 100 | 100.0 | 100.0 | 100.0 | 100.0 |

Despite the difference of about 10% less Reb A in Sample 4 (9.25% to be exact), it was unexpectedly found that the sweetness was the same between Samples 3 and 4 (a value of 6.12 in Table 3).

As shown in Table 2A, pectin was used to reduce the erythritol concentration and the concentrations of Reb A were adjusted to reach the final desired sweetness. Sample 5 is the control as this formulation offered the best tasting product for testing purposes, and has the calculated SEV of 8.78%.

TABLE 2A
Erythritol reduction and SEV in calorie-
reduced lemon lime carbonated beverages

| | % Eryth- | Ingredient (wt/wt %) | | | Sucrose Equivalence | | |
|---|---|---|---|---|---|---|---|
| | ritol | Eryth- | Reb | | Eryth- | Reb | |
| Samples | Reduction | ritol | A | Pectin | ritol | A | Total |
| 1 | 57 | 1.5 | 0.0426 | 0.0 | 0.9 | 7.06 | 7.96 |
| 2 | 57 | 1.5 | 0.0425 | 0.03 | 0.9 | 7.05 | 7.95 |
| 3 | 29 | 2.5 | 0.0400 | 0.0 | 1.5 | 6.89 | 8.39 |
| 4 | 29 | 2.5 | 0.0363 | 0.015 | 1.5 | 6.63 | 8.13 |
| 5 | NA | 3.5 | 0.0370 | 0.0 | 2.1 | 6.68 | 8.78 |

Even though Sample 4 (containing pectin) had a lower calculated SEV of 8.13 compared to the 8.39 of Sample 3, the pectin increased the level of sweetness of Sample 4 to taste comparable or equivalent as Sample 3. This is shown in Table 3 (sweetness value of Samples 3 and 4 is 6.12). In other words, theoretically, the total SEV numbers are different so one should taste a difference, but the presence of a hydrocolloid, e.g., pectin, can make an overall solution taste sweeter. The apparent SEV of pectin in Sample 4 is 0.26, and the ratio of pectin (wt/wt %) to apparent SEV is 1:17.

### 1.2 Sensory Evaluation of Calorie-Reduced Lemon Lime Carbonated Beverages

A QDA sensory evaluation was conducted on the lemon lime carbonated beverages. Approximately 1 fluid ounce of each sample was served to 10 trained expert panelists in a 2 ounce cup at temperatures from about 3° C. to about 6° C. The panelists scored each sample for the following attributes:

### Flavor:

“Maximum Time to Sweetness” refers to how quickly the time to maximum sweetness is perceived in the first sip; anywhere from 1=fast to 9=slow.

“Sweetness” refers to intensity of sweet taste at its highest peak; anywhere from 1=weak to 9=strong.

“Lemon/Lime” refers to intensity of lemon/lime flavor at its highest peak; anywhere from 1=weak to 9=strong.

“Tart/Sour” refers to intensity of tart/sour taste at its highest peak; anywhere from 1=weak to 9=strong.

“Chemical/Artificial” refers to intensity of chemical/artificial taste at its highest peak; anywhere from 1=weak to 9=strong.

“Drying/Astringent” refers to degree to which mouth feels dry/puckering as in Alum reference, rough, harsh (especially for wine), rubbery, hard or styptic. Some foods, such as unripe fruits, contain tannins or calcium oxalate that cause an astringent or rough sensation of the mucous membrane of the mouth or the teeth. Examples include tea, red wine, rhubarb, and unripe persimmons and bananas; anywhere from 1=weak to 9=strong.

“Bitter” or “Bitterness” refers to intensity of bitter taste perceived to be unpleasant, sharp, or disagreeable, on tongue and back of throat stimulated by solutions with caffeine; anywhere from 1=weak to 9=strong. Common bitter foods and beverages include coffee, unsweetened cocoa, South American “mate”, marmalade, bitter melon, beer, bitters, olives, citrus peel, many plants if the Bassicaceae family, dandelion greens and escarole. Quinine is also known for its bitter taste and is found in tonic water.

“Body” refers to the richness of flavor or impression of consistency of a sample as felt in the mouth (for example, a smoothie beverage has thicker body while water has little body); anywhere from 1=thick to 9=thin.

“Mouthcoating” refers to the cloying or sensation of coating of a sample as felt in the mouth (for example, water has having very little mouthcoating compared to vegetable oil with having a high level of mouthcoating); anywhere from 1=none to 9=very.

### After Effects

“Sweet Aftertaste” refers to the intensity of Sweetness remaining; anywhere from 1=weak to 9=strong.

“Chemical/Artificial Afterfeel” refers to the intensity of Chemical/Artificial remaining; anywhere from 1=weak to 9=strong.

“Drying/Astringent Afterfeel” refers to the intensity of Drying/Astringent taste remaining; anywhere from 1=weak to 9=strong.

“Bitter Aftertaste” refers to the intensity of Bitterness remaining; anywhere from 1=weak to 9=strong.

The panelists were asked to take one sip and rate Maximum Time to Sweetness, then take another sip and rate Sweetness, Lemon/Lime, Tart/Sour, Chemical/Artificial, Drying/Astringent, Bitterness, Body, Mouthcoating, Sweet Aftertaste, Chemical/Artificial Afterfeel, Drying/Astringent Afterfeel, and Bitter Aftertaste. The results of the mean intensity scores of the descriptive attributes are shown in Table 2.

TABLE 3A
Sensory evaluation of calorie-reduced lemon lime carbonated beverages

| | Time Max | | | | | | |
|---|---|---|---|---|---|---|---|
| Samples | Sweetness | Sweetness | Lemon/Lime | Tart/Sour | Chemical/Artificial | Drying/Astringent | Bitter |
| 1 | 1.83 | 5.95 | 4.69 | 4.15 | 3.16 | 3.09 | 2.15 |
| 2 | 2.03 | 6.04 | 5.32 | 4.34 | 3.20 | 3.45 | 2.19 |
| 3 | 1.99 | 6.12 | 5.37 | 4.14 | 3.71 | 3.32 | 2.31 |
| 4 | 1.89 | 6.12 | 5.00 | 4.15 | 2.98 | 3.25 | 2.02 |
| 5 | 1.71 | 6.68 | 5.35 | 4.38 | 3.11 | 3.19 | 1.98 |

| | | | Sweet | Chem/Artificial | Drying/Astringent | Bitter |
|---|---|---|---|---|---|---|
| Samples | Body | Mouthcoating | Aftertaste | Afterflavor | Afterflavor | Aftertaste |
| 1 | 3.74 | 3.92 | 1.87 | 2.50 | 3.36 | 1.77 |
| 2 | 4.05 | 4.55 | 2.19 | 2.30 | 3.20 | 1.77 |
| 3 | 3.82 | 4.03 | 2.32 | 2.42 | 3.29 | 1.61 |
| 4 | 3.92 | 4.15 | 2.29 | 2.40 | 3.25 | 1.72 |
| 5 | 4.06 | 4.00 | 2.12 | 2.14 | 3.35 | 1.75 |

The results showed at the highest level of erythritol reduction, i.e., at 57%, there is no statistical difference between the control (Sample 5) and Sample 2 with pectin regarding any of the aforementioned attributes. However, Sample 1 without pectin showed a significant difference (p=0.087) in sweetness as compared to the control (Sample 5), which suggests pectin can increase sweetness. The results comparing Sample 1 (without) to Sample 2 (with pectin) has a similar calculated SEV, but, while not statistically significant, the pectin in Sample 2 contributes to the enhanced perceived sweetness in the beverage composition.

### Example 1B

### Lemon Lime Carbonated Beverages

A set of experiments was conducted to evaluate the impact of varying concentrations of hydrocolloid blends (from Cargill, Incorporated) in a beverage. This is in contrast to Example 1A where the set of experiments was conducted to evaluate the impact of reducing erythritol concentrations and adding pectin.

### 1.1 Formulations of Calorie-Reduced Lemon Lime Carbonated Beverages

Calorie-reduced lemon lime carbonated beverages were prepared according to the following formulations set forth in Table 1B:

Sample 11: Reb A+2.5% erythritol
Sample 13: Reb A+2.5% erythritol+59% pectin+41% gum arabic
Sample 15: Reb A+2.5% erythritol+83% pectin+17% gum arabic

TABLE 1B
Formulations of calorie-reduced lemon lime carbonated beverages

| | Sample 11 | Sample 13 | Sample 15 |
|---|---|---|---|
| Ingredient | (wt/wt %) | (wt/wt %) | (wt/wt %) |
| Water | 98.1567 | 97.0887 | 97.1207 |
| Citric acid | 0.0983 | 0.0983 | 0.0983 |
| Potassium citrate | 0.0260 | 0.0260 | 0.0260 |
| Erythritol | 2.5 | 2.5 | 2.5 |
| Reb A | 0.024 | 0.024 | 0.024 |
| Lemon lime flavor | 0.18 | 0.18 | 0.18 |
| Sodium Benzoate | 0.015 | 0.015 | 0.015 |
| Hydrocolloid Blend | 0.0 | 0.068 | 0.036 |
| (“Blend”) | | | |
| Total | 100.0 | 100.0 | 100.0 |

TABLE 2B
SEV in calorie-reduced lemon lime carbonated beverages

| | % Eryth- | Ingredient (wt/wt %) | | | Sucrose Equivalence | | |
|---|---|---|---|---|---|---|---|
| Sam- | ritol | Eryth- | Reb | | Eryth- | Reb | |
| ples | Reduction | ritol | A | Blend | ritol | A | Total |
| 11 | 0.0 | 2.5 | 0.024 | 0.0 | 1.5 | 5.4738 | 6.9738 |
| 13 | 0.0 | 2.5 | 0.024 | 0.068* | 1.5 | 5.4738 | 6.9738 |
| 15 | 0.0 | 2.5 | 0.024 | 0.036** | 1.5 | 5.4738 | 6.9738 |

*.04 pectin and .028 gum arabic;
**.03 pectin and .006 gum arabic

### 1.2 Sensory Evaluation of Calorie-Reduced Lemon Lime Carbonated Beverages

A QDA sensory evaluation was conducted on the lemon lime carbonated beverages of Example 1B. Approximately 1 fluid ounce of each sample was served to 10 trained expert panelists in a 2 ounce cup at temperatures from about 3° C. to about 6° C. The panelists scored each sample for the following attributes:

TABLE 3B
Sensory evaluation of calorie-reduced lemon lime carbonated beverages

| | | | | Sweet | Bitter | Sour | Metallic | Other |
|---|---|---|---|---|---|---|---|---|
| Samples | Sweet | Tart/Sour | Bitter | Aftertaste | Aftertaste | Aftertaste | Aftertaste | Aftertaste |
| 11 | 5.4 | 2.7 | 1.0 | 4.0 | 1.3 | 1.9 | 2.9 | 1.1 |
| 13 | 5.7 | 2.4 | 0.4 | 4.2 | 1.2 | 2.0 | 2.9 | 1.2 |
| 15 | 5.5 | 2.4 | 1.1 | 4.2 | 1.4 | 1.9 | 2.7 | 1.4 |

The results show that, while keeping the ingredients in Table 1B constant and varying the concentrations of the hydrocolloid blends, the sweetness in Samples 11 and 13 is statistically different (p<0.05); that is, the presence of a higher concentration at 0.068 wt. % of the hydrocolloid blend accounts for an apparent SEV of 0.3. The sweetness in Samples 11 and 15 is not statistically different, which suggests that Sample 13 is just a one optimal hydrocolloid blend.

### Example 2

### Lemon Lime Carbonated Beverages

### 2.1 Formulation of Calorie-Reduced Lemon Lime Carbonated Beverages

The same calorie-reduced lemon lime carbonated beverage was made as in Example 1 except with different levels of erythritol (in this example as shown in Sample 7, a 40% reduction of erythritol).

Sample 6: Reb A+3.5% erythritol (control)
Sample 7: Reb A+2.1% erythritol+pectin (40% erythritol reduction)

TABLE 4
Formulation of calorie-reduced lemon lime carbonated beverages

| | Sample 6 | Sample 7 |
|---|---|---|
| Ingredient | (wt/wt %) | (wt/wt %) |
| Water | 96.064 | 97.447 |
| Citric acid | 0.125 | 0.125 |
| Sodium citrate | 0.024 | 0.024 |
| Erythritol | 3.5 | 2.1 |
| Reb A | 0.0375 | 0.0391 |
| Lemon lime flavor | 0.25 | 0.25 |
| Citrus Pectin | 0.0 | 0.015 |
| Total | 100 | 100.0 |

TABLE 5
Erythritol reduction and SEV of calorie-
reduced lemon lime carbonated beverages

| | % ErOH | Ingredient (wt/wt %) | | | Sucrose Equivalence | | |
|---|---|---|---|---|---|---|---|
| Samples | Reduction | ErOH | Reb A | Pectin | ErOH | Reb A | Total |
| 6 | NA | 3.5 | 0.0375 | 0 | 2.1 | 6.68 | 8.78 |
| 7 | 40 | 2.1 | 0.0391 | 0.015 | 1.26 | 6.83 | 8.09 |

The apparent SEV of pectin in Sample 7 is 0.69, and the ratio of pectin (wt/wt %) to apparent SEV is 1:46.

### 2.2 Sensory Evaluation of Lemon Lime Carbonated Beverages

In this particular example, a Triangle Test was conducted between Samples 6 and 7. A sensory panel of 59 panelists was asked to see if they tasted a difference between the control and the 40% erythritol reduced beverage (Table 6).

TABLE 6
Sensory evaluation of calorie-reduced lemon lime carbonated beverages

| Test | Probability | Trials | Successes | One Tailed P-Value |
|---|---|---|---|---|
| | 0.33333 | 59 | 27 | 0.0317 |

27 out of 59 panelists could taste the difference, while 32 could not. Pectin appears to make Sample 7 taste like Sample 6 even though the erythritol is reduced by 40%, as the apparent SEV of pectin in this experiment is 0.69 and could contribute sweetness to the overall beverage composition.

### Example 3

### Lemonade Flavored Water

### 3.1 Formulation of Calorie-Reduced Lemonade Flavored Water

A calorie-reduced lemonade flavored water was made having the following formulation: Water, Erythritol, Natural Flavor, Citric Acid, Ascorbic Acid (Vitamin C), Reb A, Niacinamide (Vitamin B3), FD&C Yellow 5, Calcium D-Pantothenate (Vitamin B5), Pyridoxine Hydrochloride (Vitamin B6), Cobalamin (Vitamin B12), and with or without pectin.

Sample 9: Reb A+2.5% erythritol (control)
Sample 10: Reb A+1.9% erythritol+pectin (25% erythritol reduction)
Sample 11: Reb A+1.5% erythritol+pectin (40% erythritol reduction)
Sample 12: Reb A+1.3% erythritol+pectin (50% erythritol reduction)
Sample 13: Reb A+1.0% erythritol+pectin (60% erythritol reduction)

TABLE 7
Formulation of calorie-reduced lemonade flavored water
Lemonade flavored water

| | Sample 9 | Sample 10 | Sample 11 | Sample 12 | Sample 13 |
|---|---|---|---|---|---|
| Ingredient | (wt/wt %) | (wt/wt %) | (wt/wt %) | (wt/wt %) | (wt/wt %) |
| Water | 97.2581 | 97.8627 | 98.2256 | 98.4674 | 98.7093 |
| Citric Acid | 0.0500 | 0.0500 | 0.0500 | 0.0500 | 0.0500 |
| Ascorbic | 0.0303 | 0.0303 | 0.0303 | 0.0303 | 0.0303 |
| Acid | | | | | |
| Reb A | 0.0200 | 0.0216 | 0.0225 | 0.0231 | 0.0238 |
| Vitamin B3 | 0.0034 | 0.0034 | 0.0034 | 0.0034 | 0.0034 |
| Lemonade | 0.1350 | 0.1350 | 0.1350 | 0.1350 | 0.1350 |
| Flavor | | | | | |
| Vitamin B5 | 0.0019 | 0.0019 | 0.0019 | 0.0019 | 0.0019 |
| Vitamin B12 | 0.0011 | 0.0011 | 0.0011 | 0.0011 | 0.0011 |
| Pyridoxine | 0.0003 | 0.0003 | 0.0003 | 0.0003 | 0.0003 |
| HCl | | | | | |
| Erythritol | 2.5000 | 1.8750 | 1.5000 | 1.2500 | 1.0000 |
| Pectin | NA | 0.0188 | 0.0300 | 0.0375 | 0.045 |
| TOTAL | 100 | 100 | 100 | 100 | 100 |

TABLE 8
Erythritol reduction and SEV of calorie-
reduced lemonade flavored water

| | % Eryth- | Ingredient (wt/wt %) | | | Sucrose Equivalence | | |
|---|---|---|---|---|---|---|---|
| Sam- | ritol | Eryth- | Reb | | Eryth- | Reb | |
| ples | Reduction | ritol | A | Pectin | ritol | A | Total |
| 9 | NA | 2.5 | 0.0200 | 0.0 | 1.5 | 4.96 | 6.46 |
| 10 | 25 | 1.88 | 0.0216 | 0.0113 | 1.13 | 5.18 | 6.31 |
| 11 | 40 | 1.5 | 0.0225 | 0.018 | 0.90 | 5.29 | 6.19 |
| 12 | 50 | 1.25 | 0.0231 | 0.0225 | 0.75 | 5.37 | 6.12 |
| 13 | 60 | 1.0 | 0.0238 | 0.027 | 0.60 | 5.45 | 6.05 |

The apparent SEV of Sample 10 is 0.15, Sample 11 is 0.27, Sample 12 is 0.34, and Sample 13 is 0.41. The ratio of pectin (wt/wt %) to apparent SEV is 13, 15, 15, and 15 respectively.

### 3.2 Sensory Evaluation of Calorie-Reduced Lemonade Flavored Water

A Duo Trio Test was conducted between a control and samples at 25%, 40%, 50%, and 60% erythritol reduction along with pectin and Reb A.

TABLE 9
Sensory evaluation of calorie-reduced lemonade flavored water
(Duo Trio Test)

| | | Number of | |
|---|---|---|---|
| | Number of | Correct | |
| Test | Respondents | Responses | p-value |
| Control (Sample 9) and 25% ErOH | 50 | 22 (44%) | 0.8389 |
| Reduction (Sample 10) | | | |
| Control (Sample 9) and 40% ErOH | 50 | 22 (44%) | 0.8389 |
| Reduction (Sample 11) | | | |
| Control and 50% ErOH Reduction | 50 | 29 (58%) | 0.1611 |
| (Sample 12) | | | |
| Control (Sample 9) and 60% ErOH | 50 | 25 (50%) | 0.5561 |
| Reduction (Sample 13) | | | |

No significant differences were noted between the samples (10 to 13) and the control sample (9). In general, the panelists could not discern a difference. Using this sensory test, up to 60% erythritol reduction is feasible using the new sweetener composition with pectin without affecting any of the sensory attributes.

Using a different discrimination sensory test, a Triangle Test was conducted between a control and samples with 40% and 50% erythritol reduction with pectin and Reb A.

TABLE 10
Sensory evaluation of calorie-reduced lemonade flavored water
(Triangle Test)

| | | Number of | |
|---|---|---|---|
| | Number of | Correct | |
| Test | Respondents | Responses | p-value |
| Control (Sample 9) and 40% | 70 | 22 (31%) | 0.675 |
| ErOH reduction (Sample 11) | | | |
| Control (Sample 9) and 50% | 67 | 39 (58%) | 0.0 |
| ErOH reduction (Sample 12) | | | |

No significant differences were noted between the 40% erythritol reduction sample and the control at the 95% confidence level. However, there were significant differences noted between the 50% erythritol reduction sample and the control at the 95% confidence level. This sensory testing method showed that 40% erythritol reduction (or up to 40% erythritol reduction) is feasible using the sweetener composition with pectin without affecting any of the sensory attributes.

### Example 4

### Raspberry Guava Flavored Water

### 4.1 Formulation of Calorie-Reduced Raspberry Guava Flavored Water

A calorie-reduced raspberry guava flavored water was made having the following formulation: Water, Erythritol, Natural Flavors, Citric Acid, Ascorbic Acid (Vitamin C), Reb A, Niacinamide (Vitamin B3), FD&C Yellow 5, Calcium D-Pantothenate (Vitamin B5), Pyridoxine Hydrochloride (Vitamin B6), Cobalamin (Vitamin B12), and with or without pectin.

Sample 14: Reb A+2.5% erythritol (control)
Sample 15: Reb A+1.5% erythritol+pectin (40% erythritol reduction)
Sample 16: Reb A+1.5% erythritol (40% erythritol reduction)

TABLE 11
Formulation of calorie-reduced raspberry guava flavored water
Raspberry guava flavored water

| | Sample 14 | Sample 16 | Sample 15 |
|---|---|---|---|
| Ingredient | (wt/wt %) | (wt/wt %) | (wt/wt %) |
| Water | 97.2981 | 98.2956 | 98.2656 |
| Citric Acid | 0.0500 | 0.0500 | 0.0500 |
| Ascorbic Acid | 0.0303 | 0.0303 | 0.0303 |
| Reb A | 0.0200 | 0.0225 | 0.0225 |
| Vitamin B3 | 0.0034 | 0.0034 | 0.0034 |
| Guava Flavor | 0.0250 | 0.0250 | 0.0250 |
| Raspberry Flavor | 0.0500 | 0.0500 | 0.0500 |
| Vitamin B5 | 0.0019 | 0.0019 | 0.0019 |
| Vitamin B12 | 0.0011 | 0.0011 | 0.0011 |
| Vitamin B6 | 0.0003 | 0.0003 | 0.0003 |
| Natural Red Color | 0.0200 | 0.0200 | 0.0200 |
| Erythritol | 2.5 | 1.5000 | 1.5000 |
| Citrus Pectin | n/a | n/a | 0.0300 |
| TOTAL | 100 | 100 | 100 |

TABLE 12
Erythritol reduction and SEV of raspberry guava flavored water

| | % Eryth- | Ingredient (wt/wt %) | | | Sucrose Equivalence | | |
|---|---|---|---|---|---|---|---|
| Sam- | ritol | Eryth- | Reb | | Eryth- | Reb | |
| ples | Reduction | ritol | A | Pectin | ritol | A | Total |
| 14 | NA | 2.5 | 0.0200 | 0.0 | 1.5 | 4.96 | 6.46 |
| 15 | 40 | 1.5 | 0.0225 | 0.018 | 0.9 | 5.29 | 6.19 |
| 16 | 40 | 1.5 | 0.0225 | 0.0 | 0.9 | 5.29 | 6.19 |

The apparent SEV of pectin in Sample 15 is 0.27, and the ratio of pectin (wt/wt %) to apparent SEV is 1:15.

### 4.2 Sensory Evaluation of Calorie-Reduced Raspberry Guava Flavored Water

A Triangle Test was conducted between a control and samples with reduced erythritol with and without pectin and Reb A.

TABLE 13
Sensory evaluation of calorie-reduced raspberry guava flavored water

| | | Number of | |
|---|---|---|---|
| | Number of | Correct | |
| Test | Respondents | Responses | p-value |
| Control (2.5% ErOH) and | 60 | 25 (42%) | 0.110 |
| 1.5% ErOH + pectin + reb A | | | |
| (compare Sample 14 to 15) | | | |
| Control (2.5% ErOH) and | 59 | 17 (29%) | 0.808 |
| 1.5% ErOH + reb A | | | |
| (compare Sample 14 to 16) | | | |

No significant differences were noted between the samples and the control at the 95% confidence level. However, the results are inconclusive because panelists did not test Sample 15 compared to Sample 16. The results showed that 40% erythritol reduction is feasible using the new sweetener composition with pectin.

### Example 6

### Agglomeration of a Portion of the Sweetener Composition

The pectin used in Examples 6 and 7 is Pectin 60417 from Cargill, Incorporated. Pectin 60417 is pectin and sucrose.

### 6.1 Preparation of Reb A-Pectin Agglomerate

About 1.4 kg of reb A was charged into a removable bowl of a batch fluid bed agglomeration unit with about 5.6 kg of citrus pectin. The reb A-pectin blend was fluidized and heated to about 35° C. to about 37° C. by adjusting the inlet air temperature of the agglomeration unit to about 65° C. Room temperature water was sprayed into the fluid bed at a spray rate of about 110 g/min to about 120 g/min for about 25 minutes.

### 6.2 Flowability of Reb A-Pectin Agglomerate

The intrinsic flowability was measured using the Dow-Lepetit device (Model #21-101-05, Hanson Research Corp., USA) following the standard operating procedure as outlined in the Flodex operation manual 21-101-000 included with the equipment. Results of 0.5 are considered poor flowability and a flowability index of 2 is considered very good flowability. The results are found in Table 14.

TABLE 14
Flowability index

| Material | Flowability Index |
|---|---|
| Citrus Pectin | 0.5 |
| Reb A | 0.4 |
| Reb A-Pectin Agglomerate | 1.0 |

The results show that agglomeration creates an agglomerate that has better flowability compared to dry blending the pectin and reb A.

### 6.3 Dissolution of Reb A-Pectin Agglomerate

A Physica MCR301 rheometer from Anton Paar GmbH (Germany) was used to measure flow properties. The MCR301 rheometer is a controlled stress rheometer that deforms a sample by applying a specified controlled stress and measures the resulting angular deflection and approximates the strain. All material properties i.e., viscosity, are calculated by the analysis of the applied stress and the resulting strain.

The option of controlled shear rates was utilized to obtain the dissolution kinetics of reb A and pectins in 20 ml of deionized water under different processing conditions. A 24 mm diameter cylindrical geometry consisting of three sets of paddles (ST24, Anton Paar) was chosen as the testing geometry. ST24's complimentary sample vessel contains a built in Peltier unit that allows precise temperature control of the sample.

The rheological measuring technique consisted of three phases: thermal equilibration of solution, preshear ramp, constant shear with addition of solutes. The first phase was achieved by utilizing the ‘wait for temperature’ feature in Anton Paar's Stat Rheoplus software that allows the test to start when the system is at the desired temperature, i.e., 30±0.1° C. The second phase consisted of a linearly increasing shear rate ramp from 0.1 to 5 s⁻¹ over 10 seconds to minimize start-up splashing effects. The third phase consisted of a constant shear rate of 5 s⁻¹ for 30 minutes with data collection occurring every 10 seconds. The dry sample was added into the sample cup at the 7 minute mark.

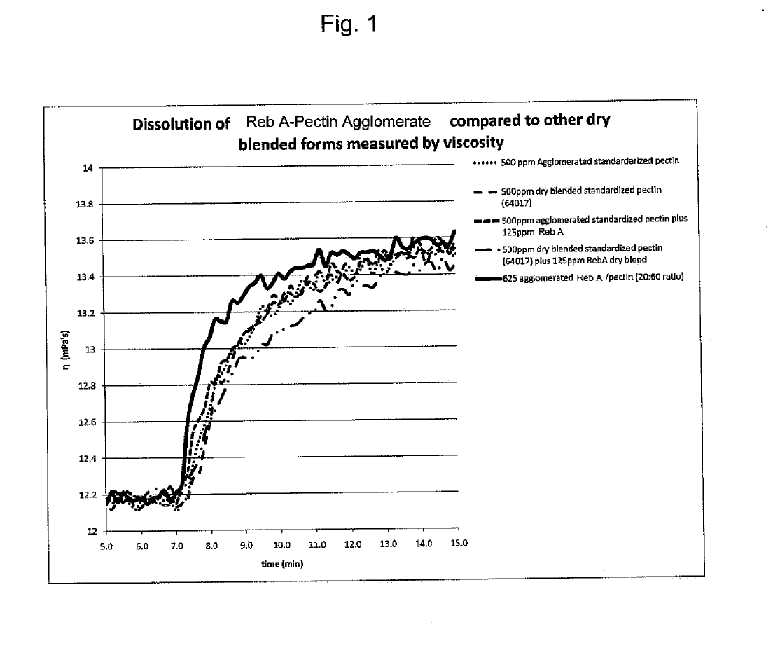

FIG. 1 shows that the reb A-pectin agglomerate (20:80) has a faster dissolution rate than dry blended materials and raw materials.

### Example 7

### Agglomeration of a Portion of the Sweetener Composition

### 7.1 Preparation of Reb A-Pectin Agglomerate

Varying amounts of reb A were charged into a removable bowl of a batch fluid bed agglomeration unit with varying amounts of pectin (see Table 15). Reb A and pectin were fluidized and heated according to Table 16 by adjusting the inlet air temperature of the agglomeration unit to between the values listed in Table 16. Room temperature water was sprayed into the fluid bed at a spray rate and time listed in Table 16.

TABLE 15
Ratios and amounts used of reb A to pectin

| | Ratio of Reb A | Amount of | Amount of |
|---|---|---|---|
| Material | to Pectin | Reb A (kg) | Pectin (kg) |
| Trial 1 | 20:80 | 1.4 | 5.6 |
| Trial 2 | 40:60 | 2.8 | 4.2 |
| Trial 3 | 60:40 | 4.2 | 2.8 |
| Trial 4 | 80:20 | 5.6 | 1.4 |

TABLE 16
Processing conditions

| | Fluidized | | | |
|---|---|---|---|---|
| Trial | Bed Heat | Air Temperature | Spray Rate | Spray Time |
| Batch | (° C.) | Range (° C.) | (g/min) | (min) |
| Trial 1 | 34-36 | 70 | 90-102 | 60 |
| Trial 2 | 30-36 | 65-85 | 101-102 | 40 |
| Trial 3 | 34-36 | 70 | 101-104 | 45 |
| Trial 4 | 33-37 | 70 | 102-105 | 55 |

### 7.2 Flowability of Reb A-Pectin Agglomerate

The intrinsic flowability was measured using the Dow-Lepetit device (Model #21-101-05, Hanson Research Corp., USA) following the standard operating procedure as outlined in the Flodex operation manual 21-101-000 included with the equipment. Results of 0.5 are considered poor flowability and a flowability index of 2 is considered very good flowability. The results are found in Table 17.

TABLE 17
Flowability Index

| Material | Ratio of reb A to pectin | Flowability Index |
|---|---|---|
| Citrus Pectin (64017) | — | 0.5 |
| Reb A | — | 0.4 |
| Trial 1 | 20:80 | 0.7 |
| Trial 2 | 40:60 | 1.0 |
| Trial 3 | 60:40 | 1.1 |
| Trial 4 | 80:20 | 1.1 |

The results show that agglomeration creates a material that has better flowability compared to dry blending the materials.

1. A calorie-reduced beverage or food composition comprising:
a. an amount of a one or more one high intensity sweetener having a SEV of from about 2.0% to about 10.0%;
b. an amount of an erythritol having a SEV of from about 0.9% to about 1.85%;
c. an amount of a one or more hydrocolloid having an equivalent mouthfeel of from about 0.5 wt. % to about 3.4 wt. % erythritol, wherein the weight ratio of hydrocolloid:erythritol herein is from about 1:50 to about 1:100; and
d. optionally, an amount of a one or more hydrocolloid having an apparent SEV of less than about 0.3, wherein the ratio of hydrocolloid (wt/wt %) to apparent SEV is from about 1:15 to about 1:50.

2. The calorie-reduced beverage or food composition according to claim 1, wherein the hydrocolloid is selected from the group consisting of pectin and gum arabic.

3. The calorie-reduced beverage or food composition according to claim 2, wherein the pectin is selected from the group consisting of sugar beet pectin, apple pectin, citrus pectin, and mixtures thereof.

4. The calorie-reduced beverage or food composition according to claim 1, wherein the high intensity sweetener is a steviol glycoside.

5. The calorie-reduced beverage or food composition according to claim 4, wherein the steviol glycoside is rebaudioside A.

6. The calorie-reduced beverage or food composition according to claim 1, wherein the erythritol is reduced from about 25% to about 60%, compared to a calorie-reduced beverage or food composition containing erythritol and rebaudioside A in the absence of a hydrocolloid wherein the SEV of the erythritol is from about 1.5% to about 3.3%.

7. (canceled)

8. A method of making a calorie reduced beverage or food composition comprising the step of adding:
a. an amount of at least one high intensity sweetener having a SEV of from about 2.0% to about 10.0%;
b. an amount of an erythritol having a SEV of from about 0.9% to about 1.85%;
c. an amount of a one or more hydrocolloid having an equivalent mouthfeel to from about 0.9 wt. % to about 2.2 wt. % erythritol; and
d. optionally, an amount of a one or more hydrocolloid having an apparent SEV of less than about 0.3, wherein the ratio of hydrocolloid (wt/wt %) to apparent SEV is from about 1:15 to about 1:50.

9. A sweetener composition comprising:
a. from about 0.2 wt. % to about 5.0 wt. % of at least one high intensity sweetener;
b. from about 92.0 wt. % to about 99.0 wt. % of an erythritol; and
c. from about 0.3 wt. % to about 3.0 wt. % of a one or more hydrocolloid.

10. The sweetener composition according to claim 9, wherein the hydrocolloid is selected from the group consisting of pectin and gum arabic.

11. The sweetener composition according to claim 10, wherein the pectin is selected from the group consisting of sugar beet pectin, apple pectin, citrus pectin, and mixtures thereof.

12. The sweetener composition according to claim 9, wherein the high intensity sweetener is a steviol glycoside.

13. The sweetener composition according to claim 12, wherein the steviol glycoside is rebaudioside A.

14. The sweetener composition according to claim 9, wherein the sweetener composition is agglomerated.

15. The sweetener composition according to claim 14, wherein the high intensity sweetener and hydrocolloid of the sweetener composition are agglomerated.

16. The sweetener composition according to claim 15, wherein the high intensity sweetener is rebaudioside A and the hydrocolloid is selected from the group consisting of pectin and gum arabic.

17. The sweetener composition according to claim 16, wherein the hydrocolloid is pectin.

18. The calorie-reduced beverage or food composition according to claim 1, wherein the at least one high intensity sweetener has a SEV of from about 4.0% to about 7.0%, the amount of a one or more hydrocolloid has an equivalent mouthfeel of from about 0.9 wt. % to about 2.2 wt. % erythritol, and the one or more hydrocolloid has an apparent SEV of less than about 0.7.

19. The method of making a calorie reduced beverage or food composition according to claim 8, wherein the at least one high intensity sweetener has a SEV of from about 4.0% to about 7.0%, and the one or more hydrocolloid has an apparent SEV of less than about 0.7.

20. The sweetener composition according to claim 9, wherein the sweetener composition comprises:
a. from about 1.1 wt. % to about 2.7 wt. % of the at least one high intensity sweetener;
b. from about 95.0 wt. % to about 98.0 wt. % of the erythritol; and
c. from about 0.6 wt. % to about 1.9 wt. % of the one or more hydrocolloid.
